(19) United States
(12) Patent Application Publication
(10) Pub. No.: US 2015/0186321 A1
(43) Pub. Date: Jul. 2, 2015

(54) INTERFACE DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: AN-LIN ZHOU, Shenzhen (CN); HE-DONG LV, Shenzhen (CN); SHENG-CUN ZHENG, Shenzhen (CN)

(21) Appl. No.: 14/583,100

(22) Filed: Dec. 25, 2014

(30) Foreign Application Priority Data
Dec. 27, 2013 (CN) 201310734598.2

(51) Int. Cl. G06F 13/40; G06F 13/42

(52) U.S. Cl. CPC G06F 13/4068; G06F 13/4282

(57) ABSTRACT

An interface device includes a motherboard, a DVI female interface, a DVI male interface, a display, and an eSATA connector. The motherboard includes a SATA controller having at least one group of differential signal pins. The DVI female interface is electronically coupled to the group of differential signal pins. The DVI male interface is coupled to the DVI female interface. The display is electronically coupled to the DVI male interface. The eSATA connector is positioned on a display and includes at least one group of differential signal pins electrically coupled to the DVI male interface. The differential signal pins of the eSATA connector configured to be in communication with the differential signal pins of the SATA controller via the DVI male interface and the DVI female interface.

### FIELD

The subject matter herein generally relates to interface devices, particularly to an interface device having a digital visual interface (DVI).

### BACKGROUND

External serial ATA (eSATA) interfaces are typically positioned on a back board of a computer chassis to connecting an external storage device, such as an external hard disk. In use, the back board usually faces away from the users and it is inconvenient for users to plug the external HDD into the corresponding eSATA interfaces.

### BRIEF DESCRIPTION OF THE DRAWINGS

Implementations of the present technology will now be described, by way of example only, with reference to the attached figures.

FIG. 1 is a block diagram of an exemplary embodiment of an interface device for input device.

FIG. 2 is a circuit diagram of the interface device for input device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

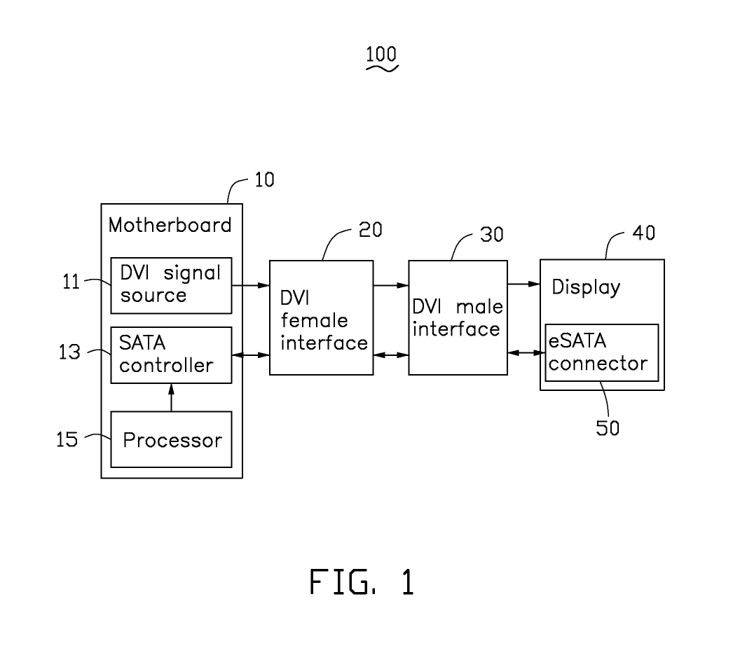

FIG. 1 illustrates an exemplary embodiment of an interface device 100 includes a motherboard 10, a digital visual interface (DVI) female interface 20, a DVI male interface 30, a display 40 and an external serial ATA (eSATA) connector 50 arranged on the display 40 and electronically connecting with the DVI male interface 30. The motherboard 10 and the DVI female interface 20 are arranged on a host device of a computer. The DVI male interface 30 is coupled to the DVI female interface 20 and coupled to the display 40 via a DVI cable.

The motherboard 10 includes a DVI signal source 11, a serial ATA (SATA) controller 13, and a processor 15. The DVI signal source 11 and the SATA controller 13 are both electrically coupled to the DVI female interface 20. The motherboard 10 provides video signals to the display 40 by a connection of the DVI female interface 20 and the DVI male interface 30. The eSATA connector 50 is electrically coupled to the SATA controller 13 via the DVI male interface 30 and the DVI female interface 20, to implement signal transmission between the eSATA connector 50 and the motherboard 10.

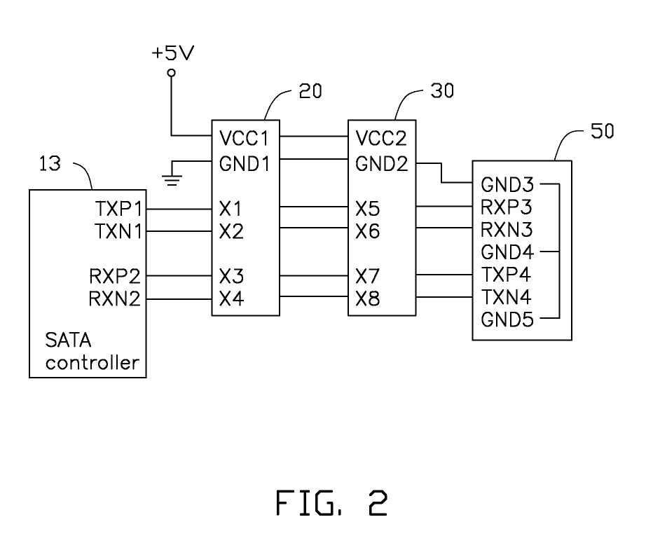

FIG. 2 illustrates that the SATA controller 13 includes two groups of differential signal pins, which includes a group of first transmit differential signal pins TXP1, TXN1 and a group of first receive differential signal pins RXP2, RXN2. In at least one embodiment, the group of first transmit differential signal pins TXP1, TXN1 can be high speed transmit differential signal pins. The group of first receive different signal pins RXP2, RXN2 can also be high speed receive differential signal pins.

The DVI female interface 20 is positioned on and is exposed from a chassis of the host device of the computer. The DVI female interface 20 includes four connecting pins X1, X2, X3, X4, a power source pin VCC1 electrically coupled to a power source, such as a +5V power source of the motherboard 10 and a ground pin GND1 connected to ground. Two of the connecting pins X1, X2 are electrically coupled to the first transmit differential signal pins TXP1, TXN1, respectively. Two of the connecting pins X3, X4 are electrically coupled to the first receive differential signal pins RXP2, RXN2, respectively. The DVI male interface 30 is positioned on and is exposed from the display 40. The DVI male interface 30 includes four connecting pins X5, X6, X7, X8, a power source pin VCC2, and a ground pin GND2 electronically coupled to the connecting pins X1, X2, X3, X4, the power source pin VCC1, and the ground pin GND1 of the DVI female interface 20 one-to-one. In at least one embodiment, the pins of the DVI female interface 20 have substantially the same function as the corresponding pins of the DVI male interface 30.

In the DVI communication protocol, a single link operation mode and a dual link operation mode are included. In the single link operation mode, the DVI interfaces transmit signals with part of the connecting pins. In the dual link operation mode, the DVI interfaces transmit signals with all of the connecting pins. In other words, when the DVI interfaces and the display corresponding to the DVI interfaces are operated under the single link operation mode, part of the connecting pins are not used. Therefore, in at least one embodiment, the four connecting pins X1, X2, X3, X4 of the DVI female interface 20 are not used when under the single link operation mode. For the same reason, the four connecting pins X5, X6, X7, X8 of the DVI male interface 30 are not used when under the single link operation mode.

The eSATA connector 50 includes two groups of differential signal pins, which includes a group of second receive differential signal pins RXP3, RXN3 and a group of second transmit differential signal pins TXP4, TXN4, and three ground pins GND3, GND4, GND5. In at least one embodiment, the group of second receive differential signal pins RXP3, RXN3 can be high speed receive differential signal pins. The group of second transmit differential signal pins TXP4, TXN4 can also be high speed transmit differential signal pins. The group of second receive differential signal pins RXP3, RXN3 are electrically coupled to two of the connecting pins X5, X6 of the DVI male interface 30, respectively. The group of second transmit differential signal pins TXP4, TXN4 are electrically coupled to the other two of the connecting pins X7, X8 of the DVI male interface 30, respectively. Therefore, the group of second transmit differential signal pins TXP4, TXN4 can establish communication with the group of first transmit differential signal pins TXP1, TXN1 via the connecting pins X5, X6 of the DVI male interface 30 and the connecting pins X1, X2 of the DVI female interface 20. The group of second transmit differential signal pins TXP4, TXN4 can establish communication with the group of first receive differential signal pins RXP2, RXN2 via the connecting pins X7, X8 of the DVI male interface 30 and the connecting pins X3, X4 of the DVI female interface 20. The three ground pins GND3, GND4, GND5 are all electrically coupled to the ground pin GND2 of the DVI male interface 30.

The processor 15 is configured to control connection states of the pins between the SATA controller 13 and the DVI female interface 20. For instance, when the display 40 is in the dual link operation mode, the processor 15 controls the SATA controller 13 to disconnect the two group of differential signal pins of the SATA controller 13 and the connecting pins of the DVI female interface 20, thus to avoid the display 40 in the dual link operation mode is interfered by SATA signals.

When the eSATA connector 50 connects an external storage device, such as an external hard disk, the SATA controller 13 transmits and receives high speed data with the external hard disk via the group of first transmit differential signal pins TXP1, TXN1 and the group of first receive differential signal pins RXP2, RXN2.

In at least one embodiment, the eSATA connector 50 is an eSATA 3G standard connector with a transmission speed of 3 Gb/s. In other embodiments, the eSATA connector 50 can be coupled to an external hard disk with an eSATA 1.5G standard.

The interface device 100 includes the eSATA connector 50 on the display 40, and the eSATA connector 50 establishes communication with the motherboard 10 via the DVI male interface 30 coupled to the display 40. Therefore, users can conveniently plug the external hard disk to the display, and the external hard disk communicates with the motherboard 10 with traditional DVI male interface 30 and DVI female interface 20.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An interface device comprising:
a motherboard comprising a serial advanced technology attachment (SATA) controller, the SATA controller comprising at least one group of differential signal pins;
a digital visual interface (DVI) female interface electronically coupled to the group of differential signal pins;
a DVI male interface coupled to the DVI female interface;
a display electronically coupled to the DVI male interface; and
an external serial advanced technology attachment (eSATA) connector positioned on a display and comprising at least one group of differential signal pins electrically coupled to the DVI male interface;
wherein the group of differential signal pins of the eSATA connector configured to be in communication with the group of differential signal pins of the SATA controller via the DVI male interface and the DVI female interface.

2. The interface device as claimed in claim 1, wherein the SATA controller comprises two groups of differential signal pins, which comprises a group of first transmit differential signal pins and a group of first receive differential signal pins.

3. The interface device as claimed in claim 2, wherein the eSATA connector comprises two groups of differential signal pins, which comprises a group of second receive differential signal pins and a group of second transmit differential signal pins.

4. The interface device as claimed in claim 3, wherein the group of first transmit differential signal pin of the SATA controller and the group of second transmit differential signal pin of the eSATA connector are high speed transmit differential signal pins; the group of first receive differential signal pin of the SATA controller and the group of second receive differential signal pin of the eSATA connector are high speed receive differential signal pins.

5. The interface device as claimed in claim 3, wherein the DVI female interface and the DVI male interface each comprises a plurality of connecting pins, the two groups of differential signal pins of the eSATA connector are electrically coupled to the two groups of differential signal pins of the SATA controller via the connecting pins of the DVI female interface and the DVI male interface one-to-one.

6. The interface device as claimed in claim 5, wherein the DVI female interface and the DVI male interface each further comprises a power pin and a ground pin, the power pins of the DVI female interface and the DVI male interface are electrically coupled to a power source of the motherboard, the ground pins of the DVI female interface and the DVI male interface are electrically coupled to ground.

7. The interface device as claimed in claim 6, wherein the eSATA connector further comprises a group of ground pins electrically coupled to the ground pin of the DVI male interface to be grounded.

8. The interface device as claimed in claim 5, wherein the connecting pins of the DVI female interface and the DVI male interface are not used when the DVI female interface and the DVI male interface are in a single link operation mode.

9. The interface device as claimed in claim 8, wherein the DVI female interface in a dual link operation mode, the processor controls the SATA controller to disconnect the two group of differential signal pins of the SATA controller and the connecting pins of the DVI female interface.

10. The interface device as claimed in claim 1, further comprising a DVI signal source and a processor, wherein the DVI signal source is electrically coupled to the DVI female interface and is configured to transmit video signals to the display via the DVI female interface and the DVI male interface.

11. An interface device comprising:
a motherboard comprising at least one group of differential signal pins;
a digital visual interface (DVI) female interface and a DVI male interface coupled to the DVI female interface; and
a display and an external serial advanced technology attachment (eSATA) connector positioned on a display and comprising at least one group of differential signal pins; the eSATA connector configured to connect to an external storage device;
wherein the group of differential signal pins of the eSATA connector configured to be in communication with the group of differential signal pins of the motherboard via the DVI male interface and the DVI female interface, thereby the motherboard are communicated with the external storage device.

12. The interface device as claimed in claim 11, wherein the motherboard comprises a serial advanced technology attachment (SATA) controller, the SATA controller comprises two groups of differential signal pins, which comprises a group of first transmit differential signal pins and a group of first receive differential signal pins.

13. The interface device as claimed in claim 12, wherein the eSATA connector comprises two groups of differential signal pins, which comprises a group of second receive differential signal pins and a group of second transmit differential signal pins.

14. The interface device as claimed in claim 13, wherein the group of first transmit differential signal pin of the SATA controller and the group of second transmit differential signal pin of the eSATA connector are high speed transmit differential signal pins; the group of first receive differential signal pin of the SATA controller and the group of second receive differential signal pin of the eSATA connector are high speed receive differential signal pins.

15. The interface device as claimed in claim 13, wherein the DVI female interface and the DVI male interface each comprises a plurality of connecting pins, the two groups of differential signal pins of the eSATA connector are electrically coupled to the two groups of differential signal pins of the SATA controller via the connecting pins of the DVI female interface and the DVI male interface one-to-one.

16. The interface device as claimed in claim 15, wherein the DVI female interface and the DVI male interface each further comprises a power pin and a ground pin, the power pins of the DVI female interface and the DVI male interface are electrically coupled to a power source of the motherboard, the ground pins of the DVI female interface and the DVI male interface are electrically coupled to ground.

17. The interface device as claimed in claim 16, wherein the eSATA connector further comprises a group of ground pins electrically coupled to the ground pin of the DVI male interface to be grounded.

18. The interface device as claimed in claim 15, wherein the connecting pins of the DVI female interface and the DVI male interface are not used when the DVI female interface and the DVI male interface are in a single link operation mode.

19. The interface device as claimed in claim 18, wherein the DVI female interface in a dual link operation mode, the processor controls the SATA controller to disconnect the two group of differential signal pins of the SATA controller and the connecting pins of the DVI female interface.

20. The interface device as claimed in claim 11, further comprising a DVI signal source and a processor, wherein the DVI signal source is electrically coupled to the DVI female interface and is configured to transmit video signals to the display via the DVI female interface and the DVI male interface.
